(19) United States
(12) Patent Application Publication
(10) Pub. No.: US 2018/0111856 A1
(43) Pub. Date: Apr. 26, 2018

(54) Process for Treating Acid Mine Drainage

(71) Applicant: Montgomery Chemicals LLC, Conshohocken, PA (US)

(72) Inventor: Charles A. Lumsden, Greensboro, GA (US)

(21) Appl. No.: 15/789,686

(22) Filed: Oct. 20, 2017

Related U.S. Application Data
(60) Provisional application No. 62/410,555, filed on Oct. 20, 2016.
(60) Provisional application No. 62/544,051, filed on Aug. 11, 2017.

(51) Int. Cl. C02F 1/52; C02F 1/56; C02F 1/66

(52) U.S. Cl. CPC C02F 1/5245; C02F 2101/206; C02F 1/66; C02F 1/56

(57) ABSTRACT

A stream of acid mine drainage is treated by mixing an alkaline aqueous solution of sodium borohydride at a pH of from 7 to 8.5 to form a metallic precipitate which is separated from the stream.

### 1. CROSS-REFERENCE TO RELATED APPLICATIONS

This application claims the priority of U.S. Provisional Application No. 62/410,555 filed Oct. 20, 2016, and U.S. Provisional Application 62/544,051, filed Aug. 11, 2017, each of which is incorporated in its entirety herein by reference.

### 2. FIELD OF THE INVENTION

The present invention relates to a process and compositions for treating water such as acid mine drainage having iron content as well as other minerals including nickel, manganese, strontium and other elements not desirable in water, and in particular manganese.

### BACKGROUND OF THE INVENTION

Mining or excavation of rock including pyrite and related minerals, such as found with coal formations, can result in water pollution. Exposure of rock containing sulfide minerals such as pyrite (FeS₂), marcasite (FeS₂ (orthorhombic)), and pyrrhotite (Fe₁₋ₓS (x=0-0.2)), to the atmosphere, such as by production of coal mine tailings, can result in oxidation of the minerals to sulfuric acid and soluble iron species. Water draining from coal mining tailings and other sources including iron sulfide and related sulfide minerals is commonly referred to as “acid mine drainage” or “acid rock drainage.” Acid mine drainage can have high concentrations of iron species, sulfuric acid, as well as other dissolved metal species, including heavy metals such as molybdenum, tungsten, chromium, manganese, nickel, arsenic, vanadium and the like. The composition of the metal species contaminating the water can vary greatly, depending on the source of the water. Likewise, mines originally used for extracting minerals such as silver, gold and copper can also produce a subsequent water drainage containing the above-mentioned dissolved metals.

A number of processes have been employed for treating by neutralizing and/or otherwise treating mine drainage. For example, acid mine drainage can be treated with bases such as calcium carbonate, calcium oxide, calcium hydroxide, sodium hydroxide, sodium carbonate, and ammonia. In addition to chemical treatments, acid mine drainage has been treated using a variety of biological treatment schemes, employing biological mechanisms to neutralize the waste water and remove metals from solution. Biological mechanisms typically rely on the construction of containment ponds and the like to subject the acid mine drainage to extended biological action.

A commonly employed method of acid mine drainage (AMD) (also known as mine impacted water) treatment is chemical precipitation of metals by increasing the pH of the discharge water to form the metal hydroxides. This is accomplished by adding various forms of lime, primarily in the forms of calcium carbonate (CaCO₃) and calcium oxide (CaO) the increasing pH of water correlates to metal hydroxide precipitation.

The dissociation of calcium hydroxide Ca(OH)₂ into Ca²⁺ and 2OH⁻ provides the resulting increasing pH. In mine impacted waters containing high concentrations of iron in relation to manganese and other metals, manganese may be removed at somewhat lower pH values than in mine waters with less iron due to co-precipitation with iron and other cation species. However, at some sites the concentration of iron is low, around 50 ppm, making it necessary to add excess CaO to increase the pH sufficiently high enough for effective Mn removal. In AMD with low concentrations of iron, the quantity of chemicals to raise the pH to high levels increases the chemical treatment cost and increases the volume of sludge generated. The higher volume of sludge necessitates a higher frequency of costly dredging and sludge removal operations.

Treatment with bases may cause the ferrous and ferric ions to precipitate and form a very hydrous, gelatinous hydrated iron hydroxide (Fe(OH)ₓ, x=2 and 3), which forms difficult to remove flocs.

A number of multi-step processes have been proposed to treat the acid mine drainage in a step-wise manner, frequently for the purpose of recovering specific metal species from the wastewater.

For example, U.S. Pat. No. 5,505,857 (“Misra”) discloses a three-step process for selectively recovering metals contained in wastewaters as metal precipitates and/or spinel ferrite and producing water suitable for discharge into the environment. In the first step, the pH is adjusted and a sulfur compound is added to precipitate at least one non-ferrous metal ion as the sulfide. In the second step, aluminum is removed by further adjusting the pH of contaminated water and adding a precipitant for the aluminum. In the final step, the pH is further adjusted to strongly alkaline and the solution is oxidized, and spinel ferrite is precipitated and removed.

U.S. Pat. No. 5,645,730 (“Malachosky”) discloses treating acid wastewater containing heavy metals such as acid mine drainage with fly ash to reduce the level of sulfate ions. In one aspect of the process, solid silicate salts are added to avoid the formation of undesirable very hydrous iron precipitates.

Active and passive chemical technologies as well as various biological strategies for treating acid mine drainage are reviewed in D. B. Johnson et al., “Acid mine drainage remediation options: a review,” Science of the Total Environment 338 (2005) 3-14, incorporated herein by reference.

There is continuing need for a process for treatment of acid mine drainage, particularly for a process which can be used to treat large quantities of wastewater quickly.

### SUMMARY OF THE INVENTION

The present invention provides an improved process for treating acid mine drainage, and in particular acid mine drainage having low levels of iron to remove manganese. The process advantageously provides a simple method for quickly treating large quantities of acid mine drainage.

In acid mine drainage and hard rock drainage projects today, limestone (calcium carbonate, calcium oxide or calcium hydroxide) is used predominantly to treat the water.

The lime does two things, it increases the pH of the water from as low as 3 to as high as 10. At a pH of 10 dissolved metal ions precipitate as metal hydroxides at the high pH. After the water is separated from the metal hydroxide, it is necessary to re-adjust the pH of the water back to about 7.0 for discharge.

In a presently preferred embodiment the present invention provides incorporating 0.3% by weight sodium borohydride into the lime (50 lbs. of 12% sodium borohydride per ton), so that metals can be separated at a pH 7.5-8.0 as the free metal not as a hydroxide.

The present invention provides the advantage of reducing the amount of lime that would otherwise be necessary to raise the pH from 8.0 to 10.0 and eliminating the need to add acid to re-adjust the pH from 10 back to 7.0.

The present invention also provides the advantage of significantly less dissolved solids in the water and the sludge generated by the additional lime.

The process optionally employs addition of a small amount of flocculent (for example, acrylic polymer) to the formulation to assist in the settling of the metals. Typically less than 0.1% flocculent can be employed.

The process preferably comprises providing a stream of acid mine drainage, discharge, or waste including iron and providing sodium borohydride. The acid mine drainage can include one or more metals detrimental to water quality, such as iron, manganese, strontium, nickel, and the like.

In one presently preferred embodiment, the acid mine waste includes water, sulfuric acid, iron and at least one heavy metal in ionic form. Preferably, the process includes providing a treatment additive selected from the group of consisting of calcium carbonate, calcium oxide, calcium hydroxide, and mixture thereof. Preferably, the process also includes providing an alkali metal borohydride, and mixing the alkali metal borohydride with the treatment additive in a ratio sufficient to reduce the at least one heavy metal ion to metallic form. Preferably, the process employs a weight ratio of the alkali metal borohydride to treatment additive of from 1.2:1000 to 1.2:100, and more preferably, the weight ratio of alkali metal borohydride to treatment additive is about 3:1000.

The process preferably also includes separating the at least one heavy metal in metallic form from the stream of acid mine drainage.

Preferably, the at least one alkali metal borohydride is sodium borohydride. Preferably, the sodium borohydride is provided as an aqueous solution.

In one aspect of the present invention, the aqueous solution is an alkaline aqueous solution which preferably includes sodium hydroxide. Preferably, the sodium borohydride is provided as an aqueous solution of sodium borohydride and sodium hydroxide.

In another aspect of the present invention, calcium carbonate is added to the acid mine drainage. In yet another embodiment, the sodium hydroxide and calcium carbonate are added to the acid mine drainage.

In one aspect of the present invention, the treatment additive and the alkali metal borohydride are mixed to form an augmented treatment additive, and the augmented treatment additive is mixed with acid mine drainage.

In one embodiment of the process, the acid mine drainage is provided as an aqueous solution having a low pH from about 3 to 7.

In another embodiment of the present invention, the pH of the mixture of acid mine drainage and sodium borohydride is adjusted to be between from about 7 to 8.5, such as by the addition of base to the sodium borohydride prior to mixing with the acid mine drainage, or such as by the addition of base to the mixture of sodium borohydride and acid mine drainage.

In one preferred embodiment of the present invention, the alkali metal borohydride is sodium borohydride and the treatment additive is calcium oxide the weight ratio of the sodium metal borohydride to calcium oxide is from 3 lbs. sodium borohydride per ton of calcium oxide to 30 lbs. of sodium borohydride per ton of calcium oxide.

Preferably, the pH of the mixture of acid mine drainage and sodium borohydride is controlled in a ratio to provide optimum effect.

In one embodiment of the process, the acid mine drainage is adjusted to a pH of from between about 7 and 8.5, and preferably from 7.5 to 8, prior to or coincident with the introduction of alkali metal borohydride provided as an aqueous solution having a pH from about 7 to 13.

Preferably, the aqueous solution of sodium borohydride employed in the process comprises from about 1 to 15 percent by weight sodium borohydride and from about 10 percent to about 42 percent by weight sodium hydroxide.

Preferably, in another embodiment the process further comprises providing sodium bisulfite and mixing the sodium bisulfite with the acid mine drainage. Preferably, in this embodiment the alkali metal borohydride is sodium borohydride, and the weight ratio of sodium borohydride to sodium bisulfite is from about 1 to 6 to about 1 to 12, and more preferably the weight ratio of sodium borohydride to sodium bisulfite is from about 1 to 8 to about 1 to 10.

In another aspect, the process includes providing a holding tank for retaining the mixture of sodium borohydride and acid mine drainage. Preferably, the holding tank has a capacity at least 20 times the flow rate of the acid mine drainage.

In another embodiment, the process further comprises subjecting the mixture to a magnetic field. Preferably, the magnetic field has an average magnetic field strength in the mixture of from about 0.2 Tesla to about 3 Tesla.

In a further embodiment, the process further comprises discharging the acid mine drainage after mixing with alkali metal borohydride to a retention pond, and preferably retaining the mixture of acid mine drainage and alkali metal borohydride in the retention pond, preferably for less than 12 hours, more preferably, for less than 6 hours, and still more preferably for less than one hour.

Preferably, sufficient alkalinity is provided to the mixture of sodium borohydride and acid mine drainage to adjust the pH of the acid mine drainage to a pH from about 7 to about 8.5, and preferably from 7.5 to 8.

In one aspect, calcium carbonate is provided in the form of limestone. In another aspect, the calcium carbonate is mixed with the acid mine drainage before mixing the sodium borohydride with the acid mine drainage. In yet another aspect, the sodium borohydride is mixed with the acid mine drainage before the calcium carbonate is mixed with the acid mine drainage. In another aspect, sodium borohydride and calcium carbonate are mixed simultaneously with the acid mine drainage.

### BRIEF DESCRIPTION OF THE DRAWINGS

FIG. 1 is a block diagram showing a first presently preferred embodiment of the treatment process of the present invention.

FIG. 2 is a block diagram showing a second presently preferred embodiment of the treatment process of the present invention.

FIG. 3 is a block diagram showing a third presently preferred embodiment of the treatment process of the present invention.

FIG. 4 is a block diagram showing a fourth presently preferred embodiment of the treatment process of the present invention.

FIG. 5 is a block diagram showing a fifth presently preferred embodiment of the treatment process of the present invention.

FIG. 6 is a graph comparing percent iron removal as a function of pH for AMD treated with slaked lime alone and AMD treated according to the process of the present invention.

FIG. 7 is a graph comparing percent manganese removal as a function of pH for AMD treated with slaked lime alone and AMD treated according to the process of the present invention.

FIG. 8 is a graph comparing the reduction in percent sludge generation as a function of both pH and concentration of sodium borohydride while treating AMD according to the process of the present invention.

### DETAILED DESCRIPTION

The present invention provides a process for treating acid mine drainage. “Acid mine drainage” is defined as aqueous effluent from mining operations, mill tailings, overburden from mining operations, excavations, acid process waste streams, seepages, and other aqueous flows having elevated levels of metal ions and/or anions. Acid mine drainage is characterized by the presence of metals such as iron, manganese, aluminum, cadmium, cobalt, copper, lead, magnesium, molybdenum, nickel, zinc, and others. Acid mine drainage may also include undesirable anions such as sulfate, fluoride, nitrate and chloride. As used in the present application, “mine” is understood to mean active, inactive or abandoned mining operations for removing minerals, metals, ores or coal from the earth. Environmental regulations promulgated by the Environmental Protection Agency under CAA, RCRA, and CERCLA, as well as those promulgated by state and local authorities, mandate that the concentration of certain minerals and metals in specific aqueous effluents be less than the established regulatory levels.

When referring to pH in this application, “about” means plus or minus one-half pH unit.

Precipitation conditions for components of acid mine drainage can be modeled using software available from the U.S. Geological Service. PHREEQCI Version 2 is a computer program for simulating chemical reactions and transport processes in water (see http://wwwbrr.cr.usgs.gov/projects/GWC_coupled/phreeqc/).

To effectively treat acid mine drainage, the present invention provides a process to remove iron from the acid mine drainage in a short time, utilizing a small volume, and without otherwise affecting the water's quality.

Advantageously, after treatment of an acid mine drainage with alkali metal borohydride, a catch basin or lagoon system can complete the water purification process, preferably with a retention time of less than 12 hours, more preferably, less than 6 hours, and still more preferably, less than one hour.

“Flocculation” means the aggregation of insoluble particles caused by the addition of a suitable flocculating agent to a particulate suspension. “Sedimentation” means the settling of the flocculated precipitated particles. Sedimentation can be effected, for example, by centrifugation, or by gravity. Flocculants useful in the process of the present invention include high molecular weight polymeric materials which achieve flocculation by bridging the suspended particles to be flocculated, as well as low molecular weight materials that adsorb to the surface of the particles to be flocculated and change the surface charge or chemistry to destabilize the particles, permitting them to coagulate. Useful flocculants include synthetic and natural organic polymers that aggregate the suspended solids permitting the solids to settle out of the slurry, resulting in a layer of settled solids and a clarified aqueous stream. Examples of useful high molecular weight water-soluble or water-dispersible flocculants include polyacrylamides such as the partially hydrolyzed, anionic polyacrylamides disclosed, for example, in U.S. Pat. Nos. 5,286,806 and 5,530,069, anionic acrylamide/acrylate copolymers such as disclosed, for example, in U.S. Pat. No. 4,138,539, cationic polyacrylamide copolymers, such as disclosed, for example, in U.S. Pat. Nos. 5,879,564 and 5,945,494, incorporated herein by reference, U.S. Patent Publication 20110147306 A1, polyacrylamides effective in flocculating suspended solids without shearing, such as disclosed in U.S. Pat. No. 6,667,374, incorporated herein by reference, polysaccharides such as hydrolyzed starches such as disclosed, for example, in U.S. Pat. Nos. 2,937,143, and 4,289,540, each enclosed herein by reference, activated starches such as disclosed, for example, in WO 2007/047481, as well as potato starches and corn starches. Lignin derivatives, such as lignosulfonates and kraft lignin, such as disclosed, for example, in U.S. Pat. No. 7,033,507, can also be used. Other examples of flocculants that can be used include methylcellulose, such a Methocel A4M (Dow Chemical Co.), ethylcellulose, hydroxypropylmethylcellulose such as Methocel F4M (Dow Chemical Co.), hydroxyethyl methylcellulose, and carboxy methylcellulose.

The most widely used organic polymeric flocculants are synthetic polyacrylamide (“PAM”)-based materials.

By “high molecular weight” is meant an average molecular weight (as determined by light scattering) of at least 100,000, and preferably greater than 1,000,000. By “anionic polymer” is meant a polymeric material having an anionic charge density. By “anionic charge density” is meant the mole percent of monomer residue in a polymer that includes an anionic chemical group, such as a carboxyl, carboxymethyl, phosphate, and sulfate chemical group.

Flocculants typically have a range of concentration over which they are particularly effective. This effective range depends upon a variety of factors, including the average molecular weight, the dispersity (monodisperse vs. polydisperse) of the polymeric flocculant, the monomer composition of the flocculant, the anionic and/or cationic charge density of the flocculant, the conformation of the polymer chains in solution, the pH of the aqueous solution, the nature and extent of crosslinking of the polymer chains if any. The flocculant of the present invention is preferably employed within the effective range.

Examples of flocculants that can be employed in the process of this invention include Metalsorb FZ (SNF Inc., Riceboro, Ga. 31323), Flowquat FL 3249 PWG polyamine, SNF Flo-PAM 956 VHM, and SNF Flo-PAM.

Examples of coagulant flocculants include polydiallyldimethyl ammonium chloride.

Sodium borohydride is preferably employed in the treatment process of the present invention. Preferably, an alkaline aqueous solution of sodium borohydride is used. Preferably, the process includes providing sodium borohydride and sufficient alkalinity to provide a mixture of sodium borohydride and acid mine drainage with a pH from about 7 to about 8.5. The alkalinity can be provided by the addition of sodium hydroxide, calcium carbonate, such as calcium carbonate in the form of limestone, or both. Sodium hydroxide in solid or aqueous solution can be added to the sodium borohydride, or to the mixture of acid mine drainage and sodium borohydride. Calcium carbonate can be added to an aqueous mixture of sodium borohydride and sodium hydroxide, or calcium carbonate can be added to the mixture of sodium borohydride, sodium hydroxide and acid mine drainage. Alternatively, calcium carbonate can be added to an aqueous solution of sodium hydroxide before mixing with sodium borohydride or a mixture of sodium borohydride and acid mine drainage. The sodium borohydride can be prepared at or near the site where the acid mine drainage is to be treated. Alternatively, the sodium borohydride can be prepared at a site remote from the treatment site, and shipped to the treatment site for use in treating the acid mine drainage. Preferably, the sodium borohydride is prepared as a stable alkaline aqueous solution such as disclosed in U.S. Pat. No. 6,866,689, incorporated herein by reference. Preferably, an aqueous alkaline solution of sodium borohydride and sodium hydroxide is mixed with the acid mine drainage in a proportion of 0.01 part by weight sodium borohydride aqueous solution to one hundred parts by weight aqueous mine drainage. Mixing can be accomplished passively, such as, for example, adding a stream of the sodium borohydride aqueous solution to a stream of acid mine drainage, and permitting the streams to mix as they continue to flow. Mixing can also be accomplished actively, such as by adding together a stream of sodium borohydride aqueous solution and a stream of acid mine drainage and actively mixing the streams together by use of mixing equipment, such as conventional paddle stirrers and the like. The mixing can occur in a continuous mode or in a batch mode.

The precipitation and removal of manganese is more complex than that of iron. Soluble manganese is thought to exist in AMD as Mn²⁺, however, it can also exist in other oxidation states of +3, +4, +6 and +7. When the pH of the drainage is raised to seven or eight, and there is sufficient time allowed for settling, most mine water will meet the standard iron concentrations and other parameters (pH 6.0-9.0, iron 1.50 mg/I). However, this treatment rarely reduces manganese when maintained at pH 8.5 in the presence of dissolved oxygen. A pH of at least 9.2 is necessary to remove manganese from solution (at this stage ˜70% Mn removal is expected) using lime. The reduction of manganese to 1.0 mg/L (30-day average discharge limit) may necessitate discharging water with a pH higher than the effluent limit of 9.0. This is the situation at some sites, whereby a variance may be granted that permits discharge of water with a pH greater than 9.0. At some sites, the CaO (quicklime or slaked lime) can be pre-dissolved or “slaked” in water and maintained at 140 degrees F. which improves the efficiency of the conversion from CaO to Ca(OH)₂ resulting in economical and efficient use of the lime.

In one aspect of the process of the present invention, sodium bisulfite is provided and mixed with the acid mine drainage. The sodium bisulfite can be premixed with the aqueous alkaline alkali metal borohydride solution, and the aqueous alkaline mixture of sodium bisulfite and alkali borohydride can then be mixed with the acid mine drainage. Preferably, the weight ratio of sodium borohydride to sodium bisulfite is from about 1 to 6 to 1 to 12, and more preferably from about 1 to 8 to 1 to 10.

After mixing the acid mine drainage and the alkali metal borohydride and optional flocculant, the mixture can be drainaged to a retention pond to permit the sodium borohydride to react with the acid mine drainage. Retention ponds are well known in the waste water treatment arts. Preferably, the mixture of acid mine drainage and alkali metal borohydride is retained in the retention pond for a period effective to substantially remove the dissolved and/or suspended iron from the acid mine drainage. The removed iron is retained in the retention pond. By “substantially remove” is meant removal of at least ninety percent by weight. Preferably, the mixture of acid mine drainage and sodium borohydride is retained in the retention pond for less than 12 hours, more preferably, for less than 6 hours, and still more preferably, for less than one hour.

In one aspect of the process of the present invention, a magnetic field is applied to the acid mine drainage to aid in removing suspended solids and/or flocculated solids including iron, such as iron in the form of ferrite. Preferable, the mixture of alkali metal borohydride and acid mine waste is exposed to a magnetic field provided with permanent magnets and/or electromagnets. Preferably, the average magnetic field strength is from about 0.2 Tesla to about 3 Tesla.

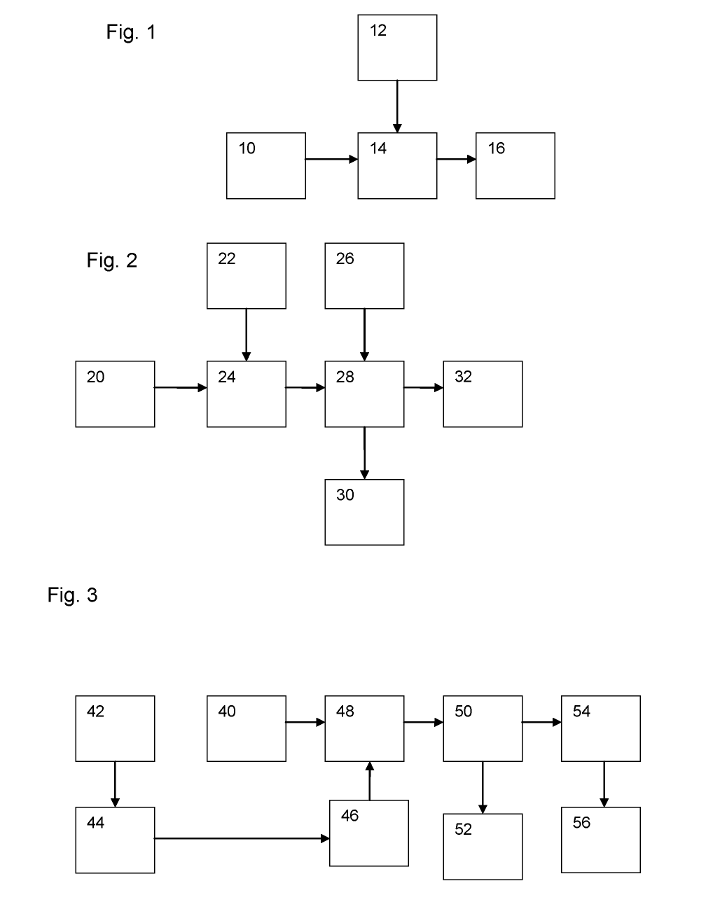

In a first presently preferred embodiment of the present invention, as illustrated in the flow diagram of FIG. 1, a stream of acid mine drainage 10 containing iron and/or other heavy metal ions and pre-treated with lime is provided. Sodium borohydride 12 is also provided. The sodium borohydride is preferably provided in the form of an alkaline aqueous solution, such as BoroMet 1240 (Montgomery Chemicals LLC, Conshohocken, Pa.), a solution of 12 percent by weight NaBH₄ in a 40 percent by weight sodium hydroxide solution. The pretreated acid mine drainage 10 and the sodium borohydride are mixed in suitable mixing equipment 14. Preferably, the application rate of the sodium borohydride to the acid mine drainage is determined by analysis of the iron content of the acid mine drainage, and the pH of the mixture is adjusted to from about 7 to about 8.5, and more preferably from 7.5 to 8. The alkaline mine drainage and the sodium borohydride can be mixed in batches, or the sodium borohydride can be provided as a continuous stream to a stream of alkaline mine drainage using suitable metering equipment. Upon mixing, a metallic precipitate 16 is formed and the precipitate 16 is separated from the stream of treated acid mine drainage.

In a second presently preferred embodiment, as illustrated in the flow diagram of FIG. 2, a stream of acid mine drainage 20 pretreated with lime and containing iron and/or one or more other heavy metal ions is provided. Sodium borohydride 22 is also provided. The sodium borohydride is preferably provided in the form of an alkaline aqueous solution, such as a solution of 12 percent by weight NaBH₄ in a 40 percent by weight sodium hydroxide solution. The acid mine drainage 20 and the sodium borohydride are mixed in suitable mixing equipment 24. Preferably, the application rate of the sodium borohydride to the acid mine drainage is determined by analysis of the iron content of the acid mine drainage. The alkaline mine drainage and the sodium borohydride can be mixed in batches, or the sodium borohydride can be provided as a continuous stream to a stream of alkaline mine drainage using suitable metering equipment. After acid mine drainage and the sodium borohydride are mixed 28, or concomitant with the mixing of the acid mine drainage and the sodium borohydride (not shown), a flocculant 26 is added to aid in forming an iron-containing precipitate 30 which is separated from the stream of treated acid mine drainage 32.

In a third presently preferred embodiment, as illustrated in the flow diagram of FIG. 3, a stream of acid mine drainage 40 containing iron and/or one or more other heavy metal ions is provided. Sodium borohydride 42 is also provided, as well as a treatment additive such as lime 44. The sodium borohydride is preferably provided in the form of an alkaline aqueous solution, such as a solution of 12 percent by weight NaBH₄ in a 40 percent by weight sodium hydroxide solution. The treatment additive 44 and sodium borohydride 42 are mixed to form an augmented treatment additive 46. The acid mine drainage 40 and the augmented treatment additive 46 are mixed in suitable mixing equipment 48. Preferably, the application rate of the sodium borohydride to the acid mine drainage is determined by analysis of the heavy metal content of the acid mine drainage. The alkaline mine drainage and the augmented treatment additive can be mixed in batches, or the augmented treatment additive can be provided as a continuous stream to a stream of alkaline mine drainage using suitable metering equipment. After acid mine drainage and the augmented treatment additive are mixed 50, or concomitant with the mixing of the acid mine drainage and the augmented treatment additive, a metallic precipitate 52 forms, which is permitted to settle out over a predefined period in a holding tank 54. The metallic precipitate 52 is then separated from the stream of treated acid mine drainage 56.

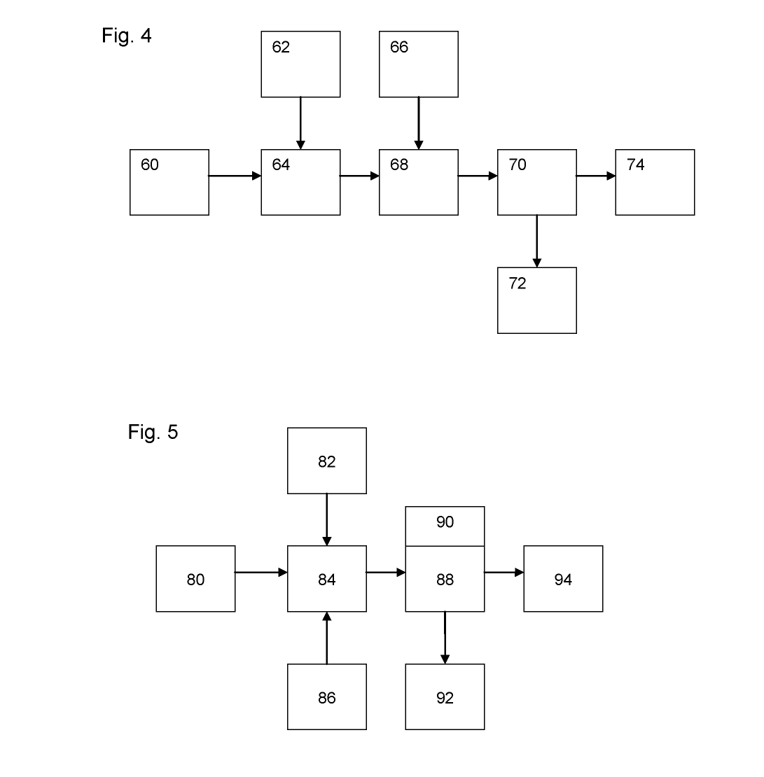

In a fourth presently preferred embodiment, as illustrated in the flow diagram of FIG. 4, a stream of acid mine drainage 60 containing at least one heavy metal ion such as iron is provided. Sodium borohydride 62 is also provided. The sodium borohydride is preferably provided in the form of an alkaline aqueous solution, such as a solution of 12 percent by weight NaBH₄ in a 40 percent by weight sodium hydroxide solution. The acid mine drainage 60 and the sodium borohydride are mixed in suitable mixing equipment 64. Preferably, the application rate of the sodium borohydride to the acid mine drainage is determined by analysis of the heavy metal content of the acid mine drainage. The alkaline mine drainage and the sodium borohydride can be mixed in batches, or the sodium borohydride can be provided as a continuous stream to a stream of alkaline mine drainage using suitable metering equipment. After acid mine drainage and the sodium borohydride are mixed 68, or concomitant with the mixing of the acid mine drainage and the sodium borohydride (not shown), a treatment additive such as sodium hydroxide, calcium carbonate, calcium oxide, or calcium hydroxide 66 is added to aid in forming a metallic precipitate 72, which is permitted to settle out over a predefined period in a hold tank 70. The metallic precipitate 72 is then separated from the stream of treated acid mine drainage 74.

In a fifth presently preferred embodiment, as illustrated in the flow diagram of FIG. 5, a stream of acid mine drainage 80 containing iron and optionally other heavy metal ion is provided. Sodium borohydride 82 is also provided. The sodium borohydride is preferably provided in the form of an alkaline aqueous solution, such as a solution of 12 percent by weight NaBH₄ in a 40 percent by weight sodium hydroxide solution. The acid mine drainage 80 and the sodium borohydride are mixed in suitable mixing equipment 84. Preferably, the application rate of the sodium borohydride to the acid mine drainage is determined by analysis of the iron content of the acid mine drainage. The acid mine drainage and the sodium borohydride can be mixed in batches, or the sodium borohydride can be provided as a continuous stream to a stream of acid mine drainage using suitable metering equipment. After acid mine drainage and the sodium borohydride are mixed 88, or concomitant with the mixing of the acid mine drainage and the sodium borohydride (not shown), a flocculant 86 is added to aid in forming metallic iron 92, in a holding tank 88, which is fitted with a set of strong permanent magnets 90. The metallic iron 92 is attracted by the magnets 90 which aid in separating the metallic iron 92 from the stream of treated acid mine drainage 94. The addition of a flocculating aid might decrease the settling time, but a 20-minute settling time suggests a holding tank or lagoon only 20 times the size of the acid mine drainage flow rate.

### Example

The effectiveness of a composition according to the present invention including both sodium borohydride and slaked lime (“MC Treatment”) was compared with that of slaked lime (“Slaked lime”) alone in treating acid mine discharge.

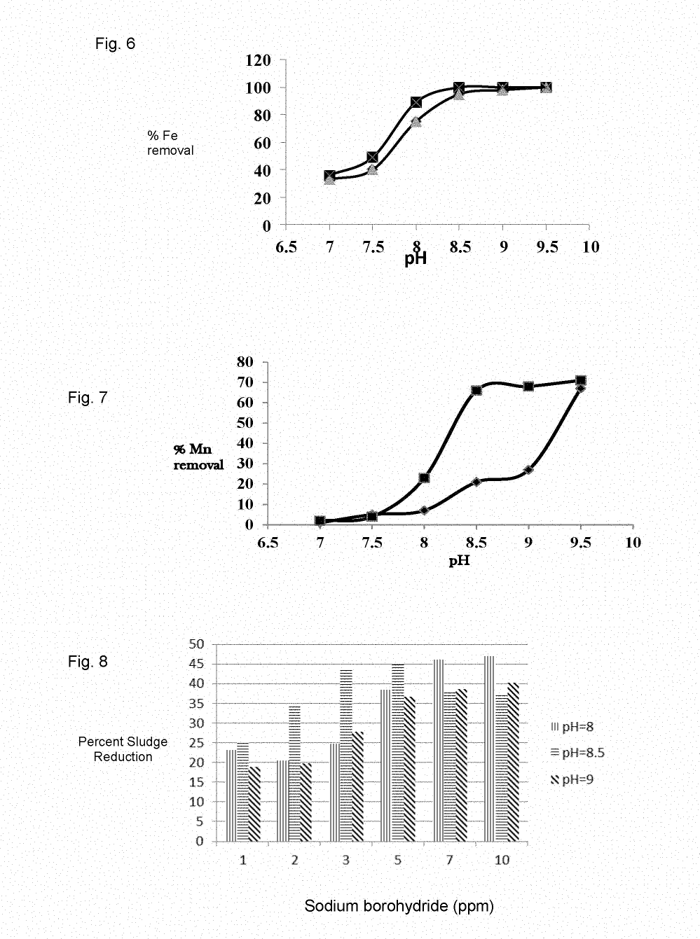

Table I and FIG. 6 show the percentage of iron removed compared with slaked lime, a current treatment method, and a method using both sodium borohydride and slaked lime (“MC additive”). Iron is present in AMD mainly as Fe²⁺, which is precipitated as iron hydroxide at around pH 8.0. Slightly higher iron removal at a lower pH is observed after pH 8.0 with the MC additive. Maximum iron removal occurs at pH 8.8 with slaked lime versus pH 8.4 for the MC additive. In both cases, maximum iron removal was the same.

TABLE 1

| | Slaked | MC + |
|---|---|---|
| pH | lime | lime |
| 7 | 33 | 36 |
| 7.5 | 40 | 49 |
| 8 | 75 | 89 |
| 8.5 | 95 | 100 |
| 9 | 98 | 100 |
| 9.5 | 100 | 100 |

FIG. 7 and Table 2 compare the effectiveness of manganese removal (as percent Mn removal) using slaked lime alone with that of MC additive. FIG. 7 shows manganese removal is approximately 40% higher at pH 8.5 with the MC additive compared to slaked lime alone. In addition, the maximum effect is reached at a lower pH in regards to the test additive—approximately pH 9 vs 9.5 for the current process. At a pH<8.0, a relatively small percentage, approximately 20% removal of manganese is observed using the process of the present invention. At the lower pH range between 8.5-9.0 iron hydroxide precipitates, and manganese co-precipitates with it. At pH values between 8.5 and 9.0, iron hydroxide re-solubilizes, and precipitated manganese also re-dissolves into solution. This is the plateau observed in the slaked lime curve of FIG. 7 between pH 8.5 and 9.0. Test results indicate the presence of Fe did not facilitate the manganese precipitation at pH 8.0 with either treatment. At pH 8.2, only around 15% of manganese was precipitated using slaked lime alone. Most notably, the use of sodium borohydride and slaked lime differs compared to slaked lime alone in a steady, linear removal of manganese after a short delay at a lower pH. With the MC additive, manganese is in a reduced state, making the co-precipitation with iron hydroxide more stable. Therefore, at a higher pH >8.0, the re-dissolution of manganese back into solution is not favorable.

TABLE 2

| | Slaked | MC + | | |
|---|---|---|---|---|
| pH | lime | lime | Mn/lime/ppm | Mn/MC + Lime/ppm |
| 7 | 1 | 2 | 4.26 | 4.21 |
| 7.5 | 5 | 4 | 4.09 | 4.13 |
| 8 | 7 | 23 | 3.99 | 3.35 |
| 8.5 | 21 | 66 | 3.4 | 1.46 |
| 9 | 27 | 68 | 3.14 | 1.38 |
| 9.5 | 67 | 71 | 1.42 | 1.25 |

FIG. 8 and Table 3 show the reduction of sludge percentage compared to slaked lime alone after MC addition. All concentrations tested showed lower amounts of sludge generation compared to the slaked lime alone. The best results in terms of percentage weight reduction of sludge compared to control were obtained at the 2.0 ppm and 3.0 ppm concentrations of sodium borohydride at pH 8.5. The data shows a 35% to 43% reduction at this pH however, at concentrations above 3 ppm at pH 9.0 a steady, approximately 40% reduction in sludge generation occurs.

TABLE 3

| | % Sludge | |
|---|---|---|
| Con/ppm | Reduction | pH |
| 1 | 23.07 | 8 |
| 1 | 25 | 8.5 |
| 1 | 18.87 | 9 |
| 2 | 20.51 | 8 |
| 2 | 34.43 | 8.5 |
| 2 | 19.68 | 9 |
| 3 | 24.79 | 8 |
| 3 | 43.87 | 8.5 |
| 3 | 27.76 | 9 |
| 5 | 38.46 | 8 |
| 5 | 44.81 | 8.5 |
| 5 | 36.66 | 9 |
| 7 | 46.15 | 8 |
| 7 | 37.74 | 8.5 |
| 7 | 38.54 | 9 |
| 10 | 47 | 8 |
| 10 | 37.26 | 8.5 |
| 10 | 40.16 | 9 |

Treatment of AMD with sodium borohydride and slaked lime is at least as effective, in iron removal, as the current process. Iron removal is a function of lime addition by itself. At pH 8.5 and 9.0 the lowest Mn concentrations obtained were with doses of the MC additive between 1.0 ppm and 3.0 ppm. Above these levels the effective Mn removal appears suppressed as evidenced by higher Mn concentrations. The samples at pH 8.5-9.0 dosed with 1.0-3.0 ppm MC additive were lower than their controls, suggesting an economic gain in CaCO₃ cost as only 50-70% of the equivalent lime dose is required to achieve the same pH. The data also suggests the discharge pH could be lower and not as critical as it is now, if a dosing scheme were employed which can maintain discharge water quality within effluent discharge limits (pH 6.0-9.0). In addition, due to a higher percentage of reduced species in the generated sludge and experience at similar sites, a faster settling process in terms of the sludge can be anticipated. Sludge generated using the MC additive is generally more stable and compact than that produced with slaked lime. If a 30-40% reduction in sludge generation were achieved, combined with faster and more compact settling, a significant amount of containment area would be reduced resulting in less frequent dredging and maintenance operations.

Use of the MC additive in treatment of AMD provides removal of iron and manganese to an equivalent value at a lower pH resulting in:

Reducing the amount of slaked lime addition by 30-50% Reduce sludge generation by 30-40%.

Reduction in overall labor costs from increased efficiency of sludge generation and decreased amounts of material to be removed.

Various modifications can be made in the details of the various embodiments of the processes of the present invention, all within the scope and spirit of the invention and defined by the appended claims.

1. A process for treating acid mine drainage to remove iron and manganese, the process comprising:
a) providing a stream of acid mine drainage including dissolve iron and manganese, the stream having a flow rate;
b) providing an alkali metal borohydride;
c) providing a treatment additive selected from the group consisting of calcium carbonate, calcium oxide, calcium hydroxide, and mixtures thereof;
d) mixing acid mine waste, treatment additive and alkali metal borohydride such that the pH of the mixture is from about 7 to about 8.5; a precipitate being formed thereby; and
e) separating the precipitate from the mixture.

2. A process according to claim 1 wherein the pH of the mixture is from 7.5 to 8.

3. A process according to claim 1 wherein the alkali metal borohydride and the treatment additive are mixed to form an augmented treatment additive, and the augmented treatment additive is subsequently mixed with the acid mine drainage.

4. A process according to claim 1 further comprising measuring the pH of the acid mine waste and calculating the amount of treatment additive required to provide a pH of from about 7 to 8.5 when the treatment additive and the alkali metal borohydride are mixed with the acid mine waste.

5. A process according to claim 1 wherein the alkali metal borohydride is sodium borohydride.

6. A process according to claim 1 further comprising adding a flocculant to flocculate the precipitate.

7. A process according to claim 6 wherein the flocculant is effective to provide a flocculated precipitate having a solids content of greater than 2 percent by weight.

8. A process according to claim 6 wherein the flocculant is selected from the group consisting of acrylamide polymers and copolymers of acrylamide and acrylic acid.

9. A process according to claim 3 further providing a holding tank for retaining the mixture of treatment additive and acid mine drainage.

10. A process according to claim 1 wherein the alkali metal borohydride is provided as an aqueous solution.

11. A process according to claim 10 wherein the aqueous solution is an alkaline aqueous solution.

12. A process according to claim 11 wherein the alkaline aqueous solution includes sodium hydroxide.

13. A process according to claim 10 wherein the aqueous solution comprises from about 1 to 15 percent by weight sodium borohydride and from about 38 to about 42 percent by weight sodium hydroxide.

14. A process according to claim 1, the process further comprising providing sodium bisulfite and mixing the sodium bisulfite with the acid mine drainage.

15. A process according to claim 12 wherein the alkali metal borohydride is sodium borohydride and the weight ratio of sodium borohydride to sodium bisulfite is from about 1 to 6 to about 1 to 12.

16. A process according to claim 1 further comprising subjecting the mixture of acid mine waste, treatment additive and alkali metal borohydride to a magnetic field, the magnetic field having an average magnetic field strength in the mixture of from about 0.2 Tesla to about 3 Tesla.

17. A process according to claim 1 further comprising discharging the mixture of acid mine drainage, treatment additive and alkali metal borohydride to a retention pond.

18. A process according to claim 15 further comprising retaining the mixture of acid mine drainage, treatment additive and alkali metal borohydride in the retention pond for less than 12 hours.

19. A process according to claim 1, wherein the alkali metal borohydride is sodium borohydride and the treatment additive is calcium oxide the weight ratio of the sodium metal borohydride to calcium oxide is from 3 lbs. sodium borohydride per ton of calcium oxide to 30 lbs. of sodium borohydride per ton of calcium oxide.
